(19) United States
(12) Patent Application Publication
(10) Pub. No.: US 2009/0172360 A1
(43) Pub. Date: Jul. 2, 2009

(54) INFORMATION PROCESSING APPARATUS EQUIPPED WITH BRANCH PREDICTION MISS RECOVERY MECHANISM

(75) Inventor: Toru Hikichi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/396,637

(22) Filed: Mar. 3, 2009

Related U.S. Application Data
(63) Continuation of application No. PCT/JP2006/317562, filed on Sep. 5, 2006.

(51) Int. Cl. G06F 9/38; G06F 9/30

(52) U.S. Cl. 712/216; 712/239; 712/E09.045; 712/E09.016

(57) ABSTRACT

The information processing apparatus comprises a cache miss detection unit detects a cache miss of a load instruction; an instruction issuance stop unit stops the issuance of an instruction subsequent to a conditional branch instruction if the branch direction of a conditional branch instruction subsequent to the load instruction for which a cache miss has been detected by the cache miss detection unit is not established at the timing of issuance, wherein a period of time cancels an issued instruction, the cancelation having been caused by a branch prediction miss, is deleted and thereby a penalty for the branch prediction miss is concealed under a wait time due to a cache miss.

### FIELD

The present invention relates to an information processing apparatus equipped with a branch prediction mistake (“miss”) recovery mechanism.

### BACKGROUND

A common instruction execution method used in a microprocessor is a method called a super scalar in which instructions are executed out of order, starting from an executable instruction. The salient characteristic of this method is that instructions are generally controlled in a pipeline, such as instruction fetch, instruction issuance, instruction execution and instruction commit, and that a branch prediction mechanism for predicting which path is correct before establishing a path for a branch instruction is commonly comprised. If a mis-hit of a branch prediction needs clearing the pipeline and establishing a correct path by restarting an instruction fetch, it might therefore be important to speed up restarting from such an instruction fetch, in addition to improving branch prediction accuracy, in order to improve the performance of a processor.

FIG. 1 is a diagram showing the configuration of a common super scalar type processor.

When an instruction fetch instruction is issued from an instruction fetch/branch prediction mechanism 10, an instruction is fetched from an L1 instruction cache 11 to be stored in an instruction buffer 12. An APB 13 is a buffer for storing an instruction to be executed when a branching is predicted but the branching to a predicted branch destination does not occur. A selector 14 inputs an instruction from either the APB 13 or the instruction buffer 12 into a decoder 15. The instruction decoded in the decoder 15 is stored in a reservation station 16 provided for a branch instruction, a reservation station 17 for an integer arithmetic operation (“operation”), a reservation station 18 for a load and store instruction, or a reservation station 19 for a floating-point operation. A decoded instruction is made to enter a commit stack entry (CSE) 23 for being committed in-order.

The reservation station 16 provided for a branching instruction examines if he instruction at the branching destination and the instruction at the established branching destination match. If both are identical, the reservation station 16 sends a report of completing a branching instruction to the CSE 23 and commits the present branching instruction. Once committed, the instruction clears a rename map 20 with which the CSE 23 converts a logic address into a physical address and causes the corresponding data in a rename register file 21 which stores data of not-committed instructions to be rewritten to a register file 22 and deletes the present corresponding data from the rename register file 21.

The reservation station 17 provided for an integer operation inputs data obtained from the rename register file 21, the register file 22, an L1 data cache 24, an L2 cache 25 or an external memory 26 into an integer operation unit 27 to be operated. The result of the operation is either written to the rename register file 21, or, in the case of using it for the immediate next operation, is given to the input of an adder 28 or given to the reservation station 16 provided for a branching instruction in order to detect the identicalness of prediction.

The reservation station 18 provided for a load instruction and a store instruction uses the adder 28 to perform an address operation in order to execute a load instruction or a store instruction, and the operation result is given to the L1 data cache 24, rename register file 21, and/or the input of the adder 28.

The configuration for performing a floating-point operation is not provided in a drawing. The control for the L1 data cache 24 and L2 cache 25 is carried out by a cache control unit 29 in accordance with a data cache access request issued from the reservation station provided for a load- and store-instruction.

Upon completing execution of the integer operation instruction, the load instruction and the store instruction, or the floating-point operation instruction, a report of the completion is reported to the CSE 23 and is committed.

FIGS. 2A through 2D are timing charts showing the machine cycles.

FIG. 2A exemplifies an integer operation instruction pipeline. FIG. 2B exemplifies a floating-point operation instruction pipeline. FIG. 2C exemplifies a load/store instruction pipeline. FIG. 2D exemplifies a branching instruction pipeline.

Referring to FIGS. 2A through 2D, “IA” is the first cycle of an instruction fetch, which is a cycle for starting the generation of an instruction-fetch address and an access to the L1 instruction cache. “IT” is the second cycle of the instruction fetch in which an L1 instruction cache tag and a branch history tag are searched for. “IM” is the third cycle of the instruction fetch, which is a cycle for matching the L1 instruction cache tag, matching the branch history tag, and carrying out a branch prediction. “IB” is the fourth cycle of the instruction fetch, the cycle in which the instruction fetch data arrives. “E” is an instruction issue pre-cycle, which is a cycle for sending an instruction from the instruction buffer to an instruction issue latch. “D” is a cycle for an instruction decode, which is a cycle for allocating various resources such as a register name and an IID and sending an instruction to the CSE/RS. “P” is a cycle for selecting an instruction with a lined-up dependency and with older instructions prioritized, from the reservation station. “B” is a cycle for reading, from a register file (RF), the source data of the instruction selected in the “P” cycle. “Xn” is a cycle in which the processing is carried out in the arithmetic operation-unit (i.e., an integer operation and floating-point operation). “U” is a cycle for reporting a completion of execution to the CSE. “C” is a cycle for a commit judgment and is executed at the same timing as “U” at the fastest case. “W” is a cycle for writing the data of an instruction commit and of a rename RF to the RF and updating a program counter (PC). “A” is a cycle for generating the address of a load/store instruction. “T” is the second cycle of a load/store instruction, for searching for an L1 data cache tag. “M” is the third cycle of the load/store instruction, for matching the L1 data cache tag. “B” is the fourth cycle of the load/store instruction, a cycle for the load data to arrive. “R” is the fifth cycle of the load/store instruction, the cycle indicating that a pipeline is completed and the data is valid. “Peval” is a cycle for evaluating the Taken or Not Taken state of a branching. “Pjuge” is for making a hit/miss judgment of a branching prediction and, if it is judged to be “miss”, the fastest timing of it is the same as the timing of the start of an instruction re-fetch.

FIG. 3 is a diagram describing a conventional problem.

A super-scalar type processor, which has been the main processor system in recent years, is characterized as using a branch prediction mechanism at an instruction fetch to determine an instruction string in a direction that is predicted to be correct, and performing an instruction execution out of order in advance of establishing a branching. If an error in a branch prediction is uncovered when a branch instruction is established, an instruction string(s) issued after instructing the branching that has been missed to be performed is discarded immediately, then the state of a central processing unit (CPU) is returned to a state that is equivalent to the point immediately after the branch instruction, and a fetching is retried starting from fetching an instruction string in the right direction immediately after a branch instruction issuance, and therefore an idle time is generated in the processing, ushering in a degraded performance.

Meanwhile, as a method for returning the state of a CPU to the state that is immediately after a branch instruction issuance when a mis-branching occurs, there is a method for initializing the various resources within a subsequent instruction CPU after committing a mis-branched branch instruction and starting the issuance of a subsequent instruction. In this case, an instruction fetch unit is independent of the various resources of an execution unit and therefore starts fetching the instruction of a subsequent instruction by initializing only the instruction fetch unit immediately after discovering a branch miss.

In this method, if a commit is carried out for as far down as a branch instruction while an instruction fetch is retried immediately after a branch instruction issuance, a fetched instruction can be issued at the fastest speed, and therefore penalties caused by a branch miss can be minimized.

If the number of cycles from establishing a branch miss to committing a branch instruction is longer than the number of cycles for a retried instruction fetch, however, an instruction issuance is stopped until a commit and therefore a degraded performance is brought about.

As a representative example of the case in which the number of cycles from establishing a branch miss to committing a branch instruction is extended, there is a case in which a load instruction generates a cache miss prior to a mis-branched branch instruction. If a cache miss occurs within a CPU so that data is supplied from dynamic random access memory (DRAM) on the system, the latency is typically up to 200 to 300 CPU cycles.

The reason why the instruction issuance is stopped until a branch instruction commit is that, in order to issue an instruction string in the right branching direction, it is preferable to return the states of resources such as the renaming register and reservation station back to states which are immediately after the branch instruction issuance or to clear the states of various resources after commitment is completed through to a branch instruction.

Further, as means for solving this problem, there is a method for storing the states of various resources for each branch instruction, returning them back to the states at the branch instruction issuance when a branch miss occurs, and continuing a branch instruction issuance in the right direction without waiting for a branch instruction commit. This method makes it possible to solve the above noted problem in view of performance, without relying on the method according to the present invention. This method is, however, faced with the problem of ushering in a enlargement of a hardware resource and an increase in the cycle time of a circuit. It is also faced with the problem that the benefit is small for a code with a low frequency of branch misses or of data cache misses, and is thus unable to justify the incorporation cost.

Conventional methods for processing a branch instruction are noted in the following reference patent documents. Laid-Open Japanese Patent Publication No. S60-3750 disclosed a technique for judging a branching simultaneously with transferring data to an arithmetic operation apparatus when the judgment of a branching cannot be made in the decoding cycle for a branch instruction. Laid-Open Japanese Patent Application Publication No. H03-131930 has disclosed a technique capable of processing without increasing the time of a stage if it is needed to stop the next instruction execution when a branching does not occur. Laid-Open Japanese Patent Application Publication No. S62-73345 has disclosed a technique used for an information processing apparatus configured to stop an instruction execution when a cache miss occurs. Laid-Open Japanese Patent Publication No. S60-3750

### SUMMARY

According to an aspects of the invention, an information processing apparatus according to the present invention is an information processing apparatus which performs a branch prediction of a branch instruction and executes an instruction speculatively, including: cache miss detection unit detects a cache miss of a load instruction; instruction issuance stop unit stops the issuance of an instruction subsequent to a conditional branch instruction if the branch direction of a conditional branch instruction subsequent to the load instruction is not established at the timing of issuance, wherein a period of time cancels an issued instruction, the cancelation having been caused by a branch prediction miss, is deleted and thereby a penalty for the branch prediction miss is concealed under a wait time caused by a cache miss.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram showing the configuration of a common super scalar type processor;

FIG. 2A is a timing chart showing a machine cycle (part 1);

FIG. 2B is a timing chart showing a machine cycle (part 2);

FIG. 2C is a timing chart showing a machine cycle (part 3);

FIG. 2D is a timing chart showing a machine cycle (part 4);

FIG. 3 is a diagram describing a conventional problem;

FIG. 4 is a diagram describing the principle of a preferred embodiment of the present invention;

FIG. 5 is an exemplary configuration of an information processing apparatus according to a preferred embodiment of the present invention;

FIG. 6 is a diagram describing a configuration for detecting the dependency between a prior load instruction and a posterior branch instruction;

FIG. 7 is a diagram showing an exemplary configuration of a cache hit/miss prediction mechanism;

FIG. 8 is a diagram showing an exemplary configuration (part 1) for detecting the probability of a branch prediction;

FIG. 9A is a diagram showing an exemplary configuration (part 2) for detecting the probability of a branch prediction;

FIG. 9B is a diagram showing an exemplary configuration (part 3) for detecting the probability of a branch prediction;

FIG. 10 is a diagram describing a branch prediction method using BHT;

FIG. 11 is a diagram showing an exemplary configuration for detecting a branch prediction probability by means of a combination between BHT and WRGHT&BRHIS;

FIG. 12 is a diagram describing a usage pattern of APB and the preferred embodiment of the present invention;

FIG. 13 is a diagram showing an exemplary timing indicating an effect provided by the present invention;

FIG. 14 is a diagram showing an exemplary instruction execution cycle when comprising a mechanism retaining a renaming map for each branch instruction and rewriting the map at a branch miss as a trigger;

FIG. 15 is a timing chart showing an exemplary operation of [method 1] and [method 2]; and

FIG. 16 is a timing chart showing an exemplary machine cycle in the case of applying the present invention when a one-entry APB is comprised.

### DESCRIPTION OF EMBODIMENTS

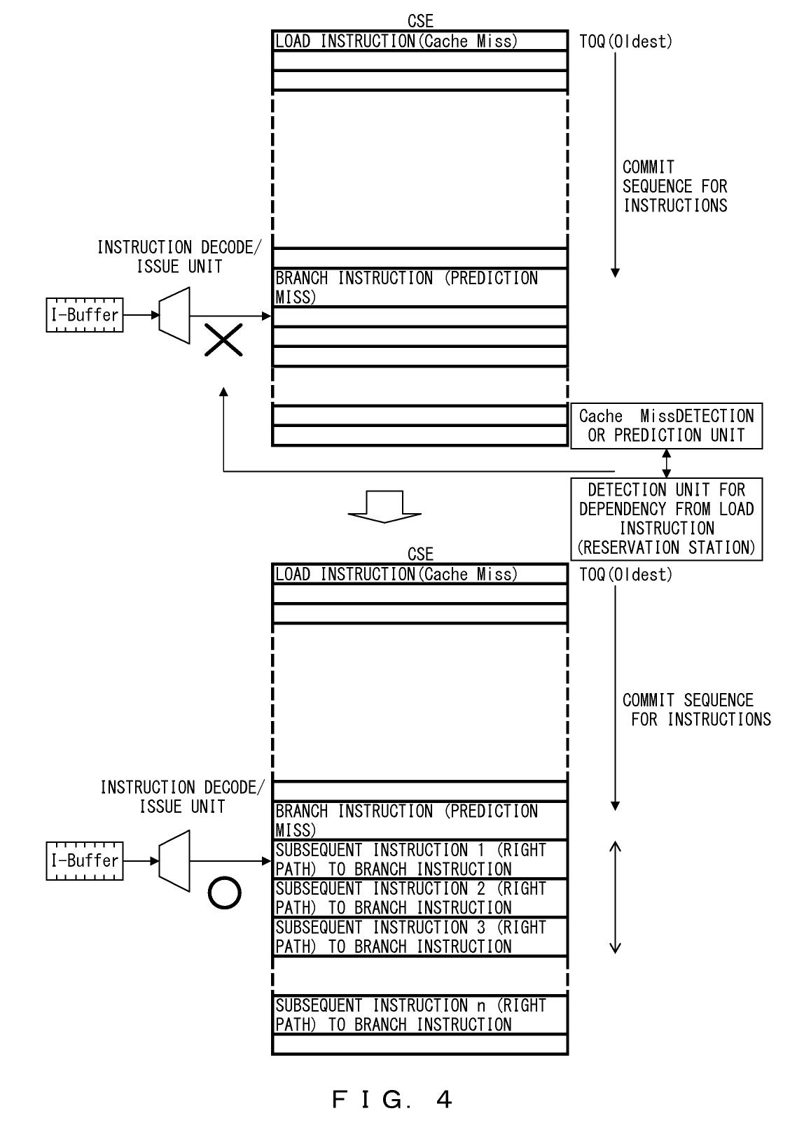

FIG. 4 is a diagram describing the principle of a preferred embodiment of the present invention.

The embodiment of the present invention is configured to solve the conventional problem by means of a relatively simple method, that is, stopping an instruction issuance. If a cache miss of Load data is either detected or predicted, a succeeding instruction issuance after a branch instruction is temporarily stopped. Even though an instruction issuance is suppressed, if a branch prediction is not hit, the issuance of a subsequent instruction can be restarted without waiting for a commitment of a branch instruction as long as a wait time for Load data is long and a branch is established before the Load data arrives, and thereby an improved performance can be realized. Also, even when the branch prediction is hit, the state in which the preceding instruction remains in the reservation station is maintained, and therefore there is a very low probability of ushering in a degraded performance compared to the case of not stopping an instruction issuance.

In order to increase the effect of the present control method in the performance, however, it is importance to appropriately select a branch instruction that is the target of stopping an instruction issuance.

In the conventional technique, the instruction issue unit of a processor is controlled to issue an instruction-fetched instruction as quickly as possible, whereas the present embodiment of the invention is configured to add an issuance stop for an instruction and a restart control thereof.
The conditions for a issuance stop and a issuance restart

[Method 1]

The conditions for stopping an instruction issuance until a conditional branch instruction is reached:

(1) It is detected or predicted that a preceding Load instruction is mis-cached (or it is only detected in the case wherein a prediction mechanism is not furnished).

(2) A branch instruction is a conditional branch instruction.

(3) A branch direction is not established at issuance.

(4) The accuracy of a branch prediction is judged to be low.

(5) The dependency on a branch instruction does not exist.

(6) The distance of a branch instruction from a Load instruction is larger than a certain threshold value.

An instruction issuance is stopped when all of the conditions noted above are satisfied.

The conditions for an issuance restart:

(1) The Load instruction predicted to be mis-cached is not actually mis-cached (which is not applicable when a prediction mechanism is not furnished).

(2) The issuance-stopped conditional branch instruction is established.

(If there is no dependency on the Load instruction with which the conditional branch instruction was mis-cached, a branch is commonly established well in advance of Load data arriving and therefore a penalty for the issuance stop is concealed under a long cache miss latency. Even though a branch miss is uncovered in this event, the issuance of a subsequent instruction can be restarted without waiting for the mis-predicted branch instruction commit before the mis-cached Load data arrives, and therefore a penalty for the branch miss can also be concealed.)

(3) The mis-cached data arrives (or an advance notice signal of the arrival is received from the cache control unit) (the reason for adding this condition is that there is a possibility of the Load data arriving first.)

An instruction issuance is restarted when all of the conditions noted above are satisfied.

In order to detect a Load instruction being mis-cached in the above described method, it is conceivable to use a method such as referring to a history table. However, this method is not practical due to an increased cost of incorporation, and accordingly the cache miss prediction mechanism may be excluded.

Further, it is possible to suppress a decrease in the execution throughput to a minimum by being limited cases in which the distance between a Load instruction and a branch instruction is a certain value.

A super scalar processor is commonly controlled in a program order by assigning the numbers in order of instructions and therefore the distance between instructions can easily be recognized.

If an implementation is capable of detecting whether or not there is dependency in a branch instruction on the Load instruction with which a cache miss has occurred, an immediate stop can be carried out when it is detected that such a dependency does not exist and therefore the operation of the stoppage is prioritized.

If an implementation is not capable of detecting whether or not there is a dependency, and if there is a dependency, it is important to determine whether or not to continue to issue an instruction(s) subsequently to one branch instruction, or a plurality thereof, with which there is a possibility that an unknown number of prediction misses subsequent to a Load instruction. That is, if the number of instructions to be issued is too small, the efficiency of out-of-order execution (in the case of no branch miss occurring) is undermined, while if the aforementioned number is too large, a penalty caused by waiting for a commit at the occurrence of a branch miss may possibly be large. That is, such a tradeoff is the reason for said importance.

In the meantime, after a branch miss is uncovered, a certain number of cycles are needed between the start of a re-fetch and the issuance of the head instruction, so that, if all instructions down to a branch instruction are completely executed and committed during the period of said cycle, an instruction issuance may be restarted without delay, and therefore an instruction issuance can be restarted after the branch miss without causing a loss due to waiting for a commit.

Such a threshold value for the number of instructions can be estimated by the following expression:

Threshold value for the number of instructions=max([the smallest number of stages from a re-fetch to the start of a head instruction issuance], [the number of stages from an instruction execution to the completion])*(execution throughput)

However, it depends on the parallelism of instructions (e.g., if a mutually independent plurality of occurrences of processing are parallelly programmed, a typical out-of-order processing is carried out), on the number of pipelines (i.e., mainly processor-specific hardware resources such as arithmetic operation units and reservation stations) which are incorporated for a parallel execution, and on the latency in executing an instruction (which is also specific to the implementation of hardware).

The higher the parallelism of instructions (i.e., there are many instructions executable independently, with the individual instructions having no mutual dependency), the higher the number of arithmetic operation units used for a parallel execution, and the smaller the latency in executing an instruction, then the larger the execution throughput.

As for the number of pipelines for a parallel execution, however, the number is meaningful only if it is no larger than the number of instructions to be executable in parallel, and even in an actual common program the number is typically two (2) each for the integer operation, floating-point operation, and the load/store instruction. Assuming that there are two pipelines respectively for the integer operation, floating-point operation, and load/store instruction and that the processing capacity for branch instructions is two simultaneous instructions per cycle, it is possible to execute a maximum of eight simultaneous instructions. However, if the number of simultaneous instruction issuances or the number of simultaneous commits is, for example, four, then the number becomes a constraint and therefore a theoretical maximum throughput is “four instructions per cycle”.

In order to implement four instructions per cycle, however, a state in which the source data to be used by an instruction-issued instruction shall be already usable (i.e., the dependency is solved) at the timing needed by the fastest execution may occur continuously, and therefore there are many cases in which the issued instruction cannot be executed at the fastest speed due to constraints such as the degree of parallelism of an actual instruction string (which is described later) and the instruction execution latency of hardware, and thus the instruction throughput is usually smaller than an ideal four instructions per cycle.

Let “Lx” be an execution latency in generating the address of an integer operation instruction and a load/store instruction, “Lf” be an execution latency in a floating-point operation instruction, “Lxl” be an execution latency in an integer load instruction, and “Lfl” be an execution latency in a floating-point load instruction.

(If the latency is different for each instruction, e.g., even between an add instruction and a shift instruction for the same integer instruction, due to the hardware integration situation, it is conceivable to use a method of directly calculating a latency by decoding an instruction occupying a reservation station. However, an average value is used for simplicity.)

Where Nx, Nf, Nx, Nxs, Nfl and Nfs are defined as the respective numbers of the integer instructions, floating-point instructions, integer load instructions, integer store instructions, floating-point load instructions, and floating-point store instructions, the operation of integer system and load, and the operation of floating-point system and load can be parallelly executed. With the degree of their execution parallelism defined as “1”, an approximation of the number of execution cycles (in the worst case) may take the larger of the respective execution time periods of the integer system and floating-point system, and therefore is represented by the following expression:

Number of execution cycles (in the worst case)=max((Nx*Lx+Nxl*Lxl),(Nf*Lf+Nfl*Lfl)) (1)

(Here, the store instruction and branch instruction, while consuming the execution pipeline, are regarded as having nothing being directly dependent thereon when a subsequent instruction is executed and therefore are excluded from the consideration.)

Further, in the case in which the arithmetic operation for generating the address of a floating point load has dependency on, for example, the load of an integer system and the result of the operation, the number of execution cycles in the worst case is represented by the following expression:

The number of execution cycles (in the worst case)=(Nx*Lx+Nxl*Lxl)+(Nf*Lf+Nfl*Lfl),

if the arithmetic operation load of the floating-point system is included as shown in the following however, the floating-point system is dominant in the execution time and therefore it is represented by the above expression (1).

Letting it be assumed to be Lx=1, Lf=6, Lxl=4 and Lfl=4, as one exemplary implementation:

The number of execution cycles (in the worst case)=max((Nx*1+Nxl*4),(Nf*6+Nfl*4))

Further, assuming that the case of the degree of parallelism being two (2) is a typical case:

The number of execution cycles (in the typical case)=max((Nx*1+Nxl*4),(Nf*6+Nfl*4))/2

In an actual program, it is in most cases difficult to increase the average degree of parallelism and therefore considering that the degree of parallelism is somewhere between one and two conceivably covers most cases.

Assuming that:

max ([the smallest number of stages from a re-fetch to the restart of a dead instruction issuance], [the number of stages from an instruction execution to the completion])=6 cycles,

the instruction threshold value can be represented by the following expression:
In the worst case:

max((Nx*1+Nxl*4),(Nf*6+Nfl*4))=6
In a typical case:

max((Nx*1+Nxl*4),(Nf*6+Nfl*4))/2=6

If a threshold value with the number of instructions represented by the above expression defined as the upper limit is taken, it is possible to prevent an extraneous CPU cycle due to the waiting time for a commit.

Furthermore, if an implementation is capable of judging a possibility of a branch miss, a method conceivable as a combination, for example, is to adopt the worst case, if the possibility of branch misses is judged to be high, and to adopt the typical case or to continue to issue instructions while ignoring a threshold value if the possibility of branch misses is judged to be low.

[Method 2]

The hardware used for an instruction issuance stop condition and for detecting the dependency in the above described method has a relatively high implementation cost, and therefore implementing it only to embody the present invention is not so beneficial.

Accordingly, method 2 is configured to detect dependency with method (1) or (2), as described in the following as simplified alternative means in place of precisely detecting dependency.

(1) When no detection of dependency is performed at all, this is indiscriminately regarded as no dependency existing. If a branching direction is not established in the elapse of a certain period of time after stopping an instruction issuance, an instruction issuance is restarted by assuming that there is dependency on the load data.

(2) A conditional branch instruction which refers to an integer condition code (CC) against the load of floating-point data, and, conversely, a conditional branch instruction which refers to a floating-point CC against the load of integer data, are respectively regarded as no having dependency.

The conditions for stopping instruction issuance as far down as a conditional branch instruction:

(1) It is detected that the precedent Load instruction has been mis-cached.

(2) A branch instruction is a conditional branch instruction.

(3) A branch direction is not established at issuance.

(4) The accuracy of a branch prediction is judged to be low.

(5) There is no dependency on a branch instruction (or it is the number of certain instructions apart from a load instruction).

An instruction issuance is stopped if all of the above conditions are satisfied.

The conditions for restarting issuance:

(1) An issuance-stopper conditional branch instruction is established. (If there is no dependency on the load instruction for which the conditional branch instruction has been mis-cached, a branch is commonly established sufficiently earlier than the arrival of load data, and therefore the penalty for the issuance stop is concealed under a large cache miss latency. Even though a branch miss is uncovered, the issuance of a subsequent instruction can be started without waiting for the prediction-missed branch instruction commit before the mis-cached load data arrives, and therefore the penalty for the branch miss can also be concealed).

(2) Mis-cached load data arrives (or an advanced signal of an arrival is received).

(There is a possibility of the load data arriving first, including the case of dependency existing even though the dependency has been judged to not exist.)

The issuance of an instruction is restarted if all of the above conditions are satisfied.

[Example of Processing for Judging the Accuracy of a Branch Prediction]

As an exemplary processing for judging a case in which the accuracy of a branch prediction is low in the above described methods 1 and 2, the following examples are conceivable in accordance with a branch prediction method in use.

It is beneficial to implement either method by applying a branch prediction circuit, which is used for processor hardware, as much as possible.

(1) A method for judging the case of predicting in a direction opposite to a software-wise branch prediction, with the certainty of the prediction being low.

In a SPARC V9 instruction set, there is a type possessing an instruction field which is called a P-bit indicating software-wisely an ease of branching in a conditional branch instruction. If the branch prediction is opposite to the P-bit, the probability of the branch prediction is judged to be low.

(2) BHT (Branch History Table) Method

In the case of the BHT method that refers to a table comprising an instruction fetch address and 2-bit saturation counter using an instruction address or the like, there are methods of counting using Taken and Not Taken used as references and methods (i.e., Agree Predict) of counting in either a direction along a P-bit predicted software-wisely or in a direction opposite to this direction.

<The Case of Using Taken and not Taken as References>

00: Strongly taken

01: Weakly taken

10: Weakly not taken

11: Strongly not taken

<The Case of Using Agree or Disagree Against a P-Bit>

00: Strongly disagree

01: Weakly disagree

10: Weakly agree

11: Strongly agree

A combination between an instruction fetch address and a branch history register (BHR) (i.e., a register generated by shifting a pattern, i.e., Taken and Not Taken, of a close-by conditional branch instruction bit-by-bit for each conditional branch prediction) is used for a table search, and an update is performed by incrementing+1 or −1 at a conditional branch instruction fetch or when a branch prediction miss is uncovered in terms of a correction at a fetch.

In this method, the probability of a prediction can be judged to be low at a “Weakly” prediction (i.e., the counter values=01 and 10).

(3) A Branch Prediction Method with a Plurality of Layers

Branch History+WRGHT method is taken as an example.

The Branch History registers, in a table, a branch instruction predicted as Taken and deletes, from the table, a branch instruction predicted as Not Taken. The Branch History searches with a fetch address. If the search result hits, the branch instruction is predicted by the address as Taken. Non-branch instructions and Not Taken instructions are judged as not being hit by a search and as an instruction string linearly progressing.

In accordance with the branch prediction and result, the following processes are carried out.

The Branch History is assumed to have the capacity of, for example, a 16K entry.

Although the WRGHT has a limited number of entries and this number is smaller than the Branch History, the WRGHT drastically improves the prediction accuracy of the above described Branch History. The WRGHT has the information for the immediate three times as to how many times Taken and Not Taken have continued for the immediately preceding 16 conditional branch instructions (meaning that the branch directions have changed two times in the meantime).

While this method performs a more accurate prediction for the conditional branch instructions stored in the immediately preceding minimum quantity entries (e.g., 24 entries), if there is no entry in the WRGHT resulting from the conditional branch instructions being output individually, the accuracy of the prediction is regarded as being relatively low.

(4) A Predicted Branch Prediction Method Obtained by Combining a Plurality of Branch Prediction Methods

As seen in paragraphs (2) and (3) above, there are strengths and weaknesses depending on the branch prediction method. Accordingly, there is a method of predicting by selecting the most likely case from among the results of a plurality of branch prediction methods.

The method equipped with a plurality of prediction methods and a branch prediction result right/wrong history counter table for selecting a prediction method, for improving the accuracy of prediction:

The branch prediction result hit/miss history counter table is typically a method of searching for a 2-bit saturation counter with an instruction address. For the respective prediction methods, the 2-bit saturation counter changes by +1 if the prediction is right, or by −2 if the prediction is wrong.

The selection of any one for a branch prediction is carried out by selecting a larger value from the result of comparing the magnitude of the counter values. (If those values are the same, a method indicating an on-average better performance in the actual prediction results of a typical benchmark program is selected.)

In this method, if all the values of the prediction counters of all methods are low, the accuracy of prediction is regarded as being low.

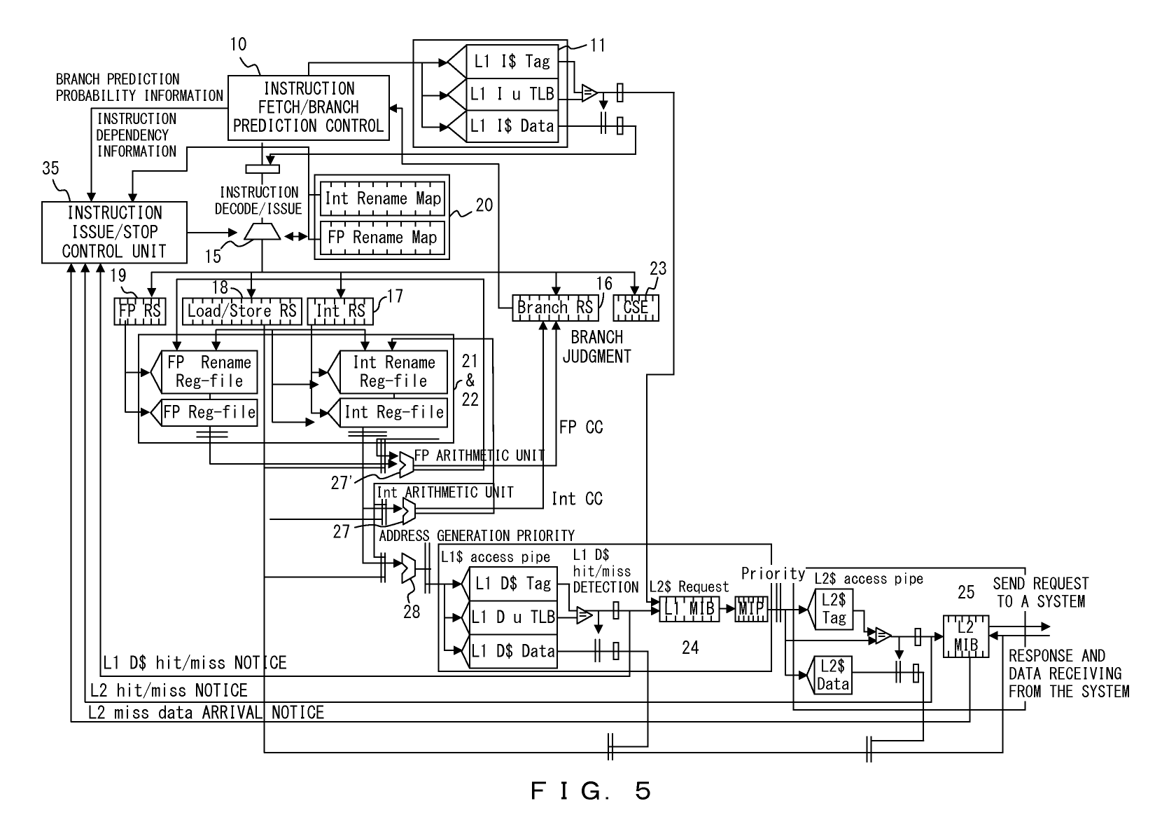

FIG. 5 is an exemplary configuration of an information processing apparatus according to a preferred embodiment of the present invention.

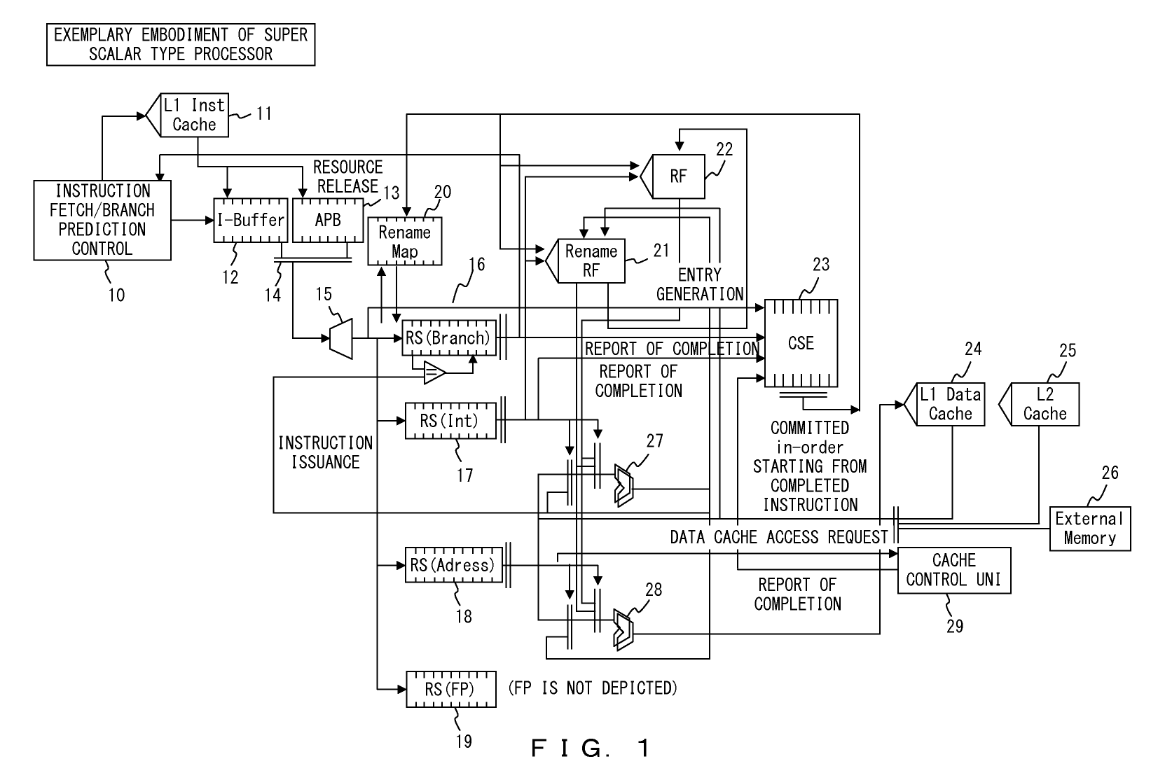

In the delineation of FIG. 5, the same reference number is assigned to the same constituent component as FIG. 1 and the description is not provided here.

In FIG. 5, “$” represents a cache. Therefore, “L1I$” represents an L1 instruction cache. For example, in L1 instruction cache 11, a tag of a logic address is compared with a result obtained by converting the logic address with L1I$ TLB and, if they are identical, the corresponding instruction is extracted from L1I$ Data. Here, “L1IμTLB” represents an L1 instruction micro TLB. In the L1 data cache, a logic address input from the address generation adder 28 is taken as input, a logic address tag is compared with the value of a post-TLB conversion and, if there is a hit, the data is read from the L1D$ Data. If there is no hit, an access request to an L2 cache is stored in an L1 move-in buffer (L1MIB) and is sent to an L2 cache 25 by way of an MI port (MIP). Here, the L2 cache is configured to be accessed with a physical address, and therefore a TLB is not furnished. If there is also a miss in the L2 cache, an external memory is accessed.

Meanwhile, although a floating-point arithmetic operation unit 27′ is noted in FIG. 5, the operation is basically the same as an integer arithmetic operation unit. Furthermore, the rename map 20 and rename register files 21 and 22 are respectively equipped with arithmetic operation units for integer operation and floating point operation.

The above description has parts in common with FIG. 1, although the mode of notation is different from FIG. 1, and represents a common configuration of a conventional super scalar type processor. The embodiment of the present invention is equipped with an instruction issue/stop control unit 35 for carrying out the above described processes. The instruction issue/stop control unit 35 receives branch prediction probability information from an instruction fetch/branch prediction unit 10, receives instruction dependency information from the rename map 20, and receives an L1 data cache hit/miss notice, an L2 cache hit/miss notice, and an L2 miss data arrival notice from the L1 cache 24 and L2 cache 25.

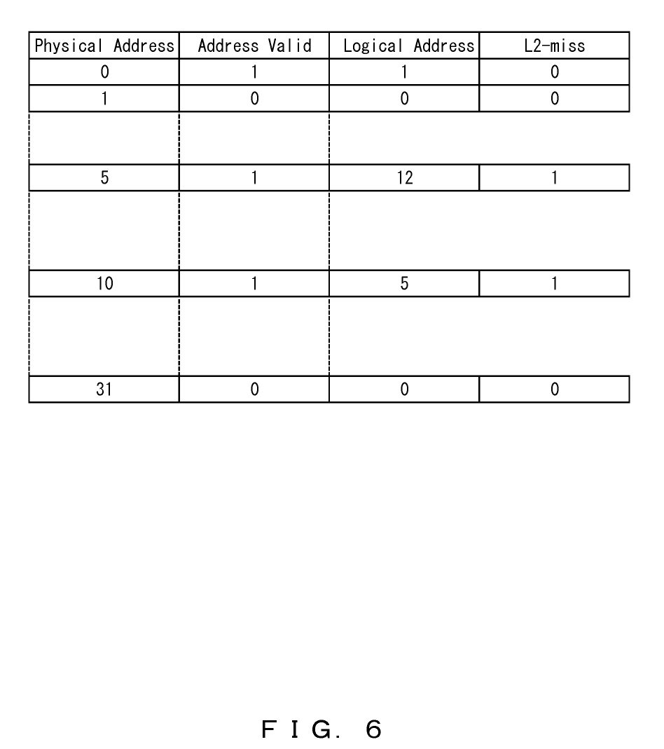

FIG. 6 is a diagram describing a configuration for detecting the dependency between a prior load instruction and a posterior branch instruction.

FIG. 6 shows each entry of the rename map. The physical address and logic address of a pre-commit instruction have entries in the rename map. Each entry is furnished with an L2-miss flag for indicating whether or not there is an L2 cache miss. The equipping of each entry with the L2-miss flag as such makes it possible to refer to the L2-miss flag of the entry of an instruction needed to generate a condition code (CC) and to get information as to whether or not there is a cache miss when the CC of a branch instruction is generated in a later event.

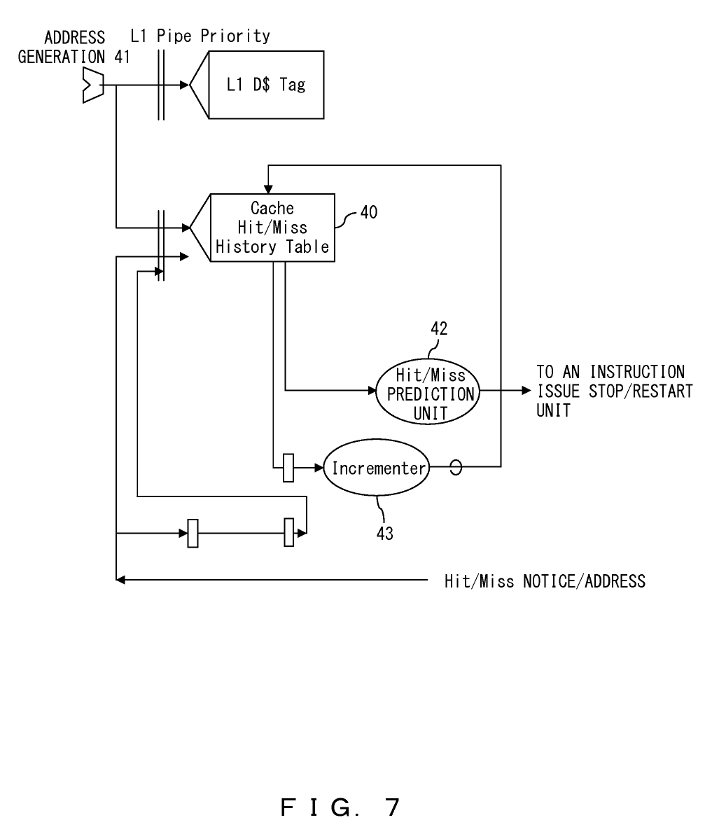

FIG. 7 is a diagram showing an exemplary configuration of a cache hit/miss prediction mechanism.

An address output from a load- and store-use address generator 41 is input into the tag process unit of an L1D cache, while the configuration shown in FIG. 7 is equipped with a cache hit/miss history table 40. The cache hit/miss history table 40 is provided for receiving a notice of a cache miss or cache hit and storing the value obtained by counting the number of cache misses and hits for each index of the L1 cache. That is, the cache hit/miss history table 40 stores the number of L1 hits and the number of L1 misses, for each index, as counter values of about 4 bits and, if the number of L1 misses is relatively large (i.e., having a magnitude of one half or ¼ or larger for 16 values expressed with 4 bits), regards the probability of a miss as being high. It increments a hit value by +1 at a hit or a miss value by +1 at a miss. After either the hit value or the miss value overflows and then when a cache hit or miss occurs, both the hit value and miss values may be cleared. The configuration is such that a search is basically carried out simultaneously with an L1 access and also such that the cache hit/miss table can be searched even when the L1 cache is busy due to another high priority cause. A hit/miss prediction unit 42 predicts whether or not there may be a cache hit or miss and reports the result of the prediction to an instruction issue stop/restart control unit. An incrementer 43 is provided for incrementing the hit value or miss value at every cache hit or miss.

If the cache is predicted to be hit, the instruction issuance may be continued, while if a cache miss is predicted, the instruction subsequent to the conditional branch instruction may be stopped. However, sometimes the prediction can be off. Therefore, if a hit is established when the prediction was a miss, an instruction issuance is immediately restarted, whereas if a miss is established when the prediction was a hit, an instruction issuance is immediately stopped.

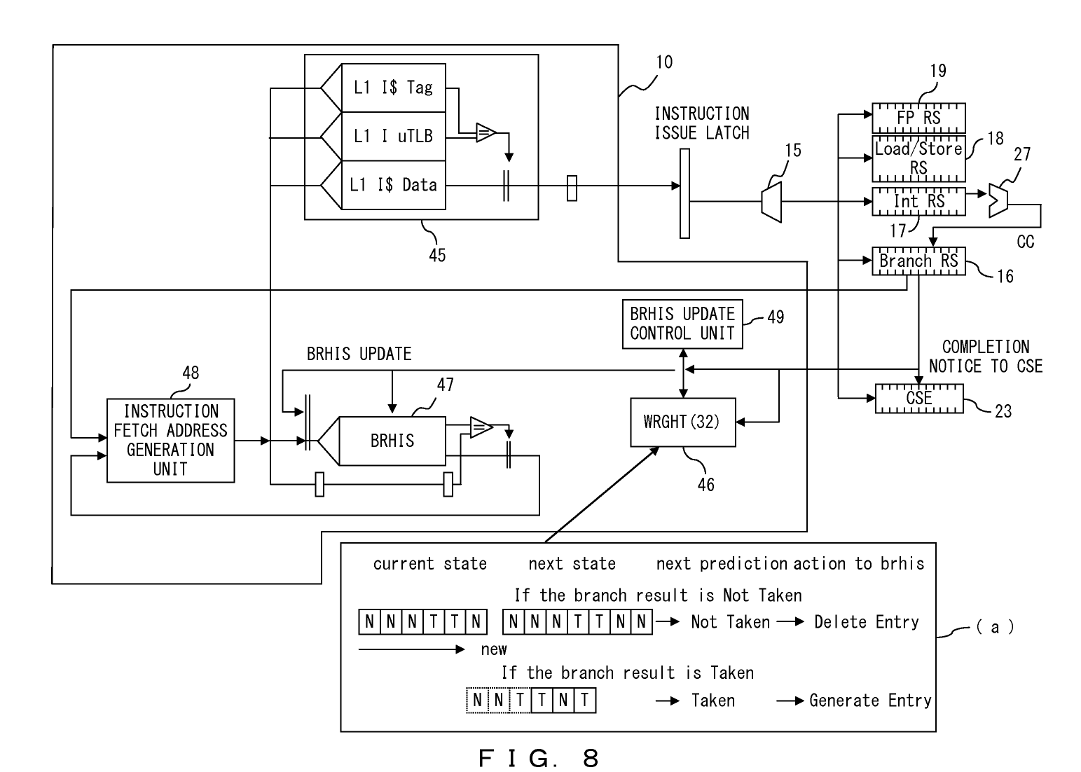

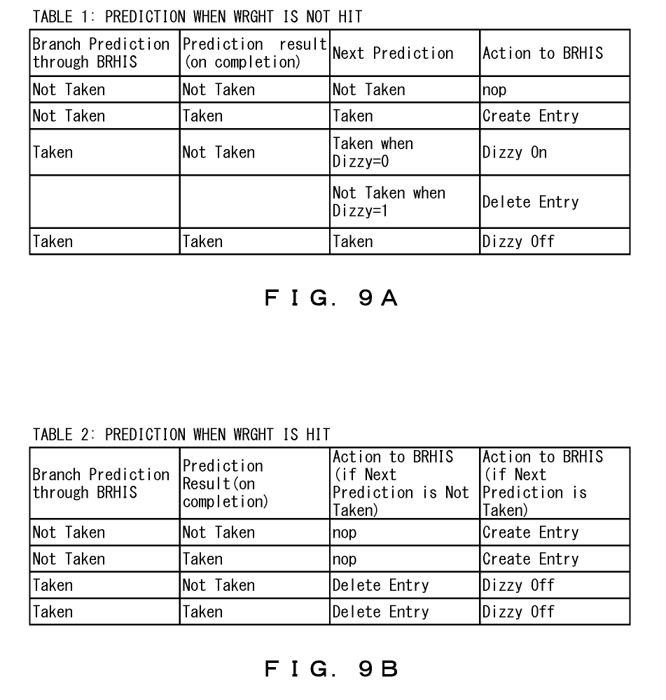

FIG. 8, FIG. 9A and FIG. 9B are diagrams showing an exemplary configuration for detecting the probability of a branch prediction. FIG. 8 is a configuration using the WRGHT. The WRGHT is described in detail in Laid-Open Japanese Patent Application Publication No. 2004-038323 and therefore it is outlined in the following.

Referring to FIG. 8, the same reference sign is assigned to the same constituent component as FIG. 5. When an instruction fetch address is issued from an instruction fetch address generation unit 48, the address is input into an L1 cache 45 so that the instruction is executed, and is also input into a branch history 47 so that a branch prediction is carried out. Once a branch is established by executing a branch instruction, an established branch destination is input from a branch instruction-use reservation station 16 to a WRGHT 46 and a branch history BRHIS 47. The WRGHT 46, also called a local history table, is furnished for storing a branch history for each instruction of each address. The WRGHT 46 and branch history BRHIS 47 cooperate to carry out a branch prediction vested with the probability of prediction. The following is a description of the WRGHT 46 based on the diagram drawn in rectangle (a) of FIG. 8. Let it be assumed that the present state is NNNTTN. Here, the past branch result is represented by “N” for Not Taken and “T” for Taken. If the branch result is Taken in the next time, the state is shifted to NNNTTNN. The first N is repeated three times in this event, and the next N is predicted to repeat three times so that the next branch prediction is determined to be N, that is, Not Taken. Then the corresponding entry of the branch history BRHIS 47 is deleted. This prompts the prediction that T is repeated two times since the T repeated two times and predicts the next branch prediction as T. Then, an entry is generated in the BRHIS 47.

After a branch for a conditional branch instruction is established, the WRGHT 46 sends the branch information to a branch history (BRHIS) update control unit 49 at the same time as sending a completion notice to the CSE 23, thereby updating the BRHIS 47. The BRHIS 47 pre-deletes the entry, thereby determining the branch prediction for the next time as Not Taken, and registers an entry, thereby providing the information that the next branch prediction is predicted as Taken. If there is no entry in the WRGHT 46, a branch is predicted with the logic shown in table 1 of FIG. 9A and the BRHIS 47 is updated.

If there is an entry in the WRGHT 46, a branch is predicted with the logic shown in table 1 of FIG. 9A and thereby the BRHIS 47 is updated. Basically, if Taken is repeated for the branch instruction, it is predicted that Taken will be further repeated if the number does not match the number of times Taken was repeated the last time, and that Taken will be changed to Not Taken the next time if both numbers match each other.

Meanwhile, an event in which an entry is registered in the WRGHT 46 is regarded as Taken due to a branch miss, in which case the oldest entry is discarded.

If there was a branch miss upon registering an entry in the WRGHT 46 the previous time so that there was no hit in the WRGHT 46, a Dizzy flag, which indicates a degree of probability of prediction, becomes “1”, and therefore:

High degree of probability of prediction: Dizzy_Flag=0 at prediction

Low degree of probability of prediction: Dizzy_Flag=1 at prediction

In tables 1 and 2 of FIGS. 9A and 9B, the first column is “a branch prediction using BRHIS”, with the results being Taken or Not Taken. The second column is “a branch result after the branch is established”. The third column in table 1 is “the next branch prediction content” and in table 2 is “an operation on BRHIS when the next branch prediction content is Not Taken”. The fourth column in table 1 is “an operation on BRHIS” and in table 2 is “an operation on BRHIS when the next branch prediction content is Taken”. The Dizzy flag, being a flag registered in the BRHIS, indicates that the probability of prediction is high if the flag is “off”, that is, if Dizzy_Flag is “0”, and that the probability of prediction is low if the flag is “on”, that is, if Dizzy_Flag is “1”. Meanwhile, “nop” indicates that nothing is done.

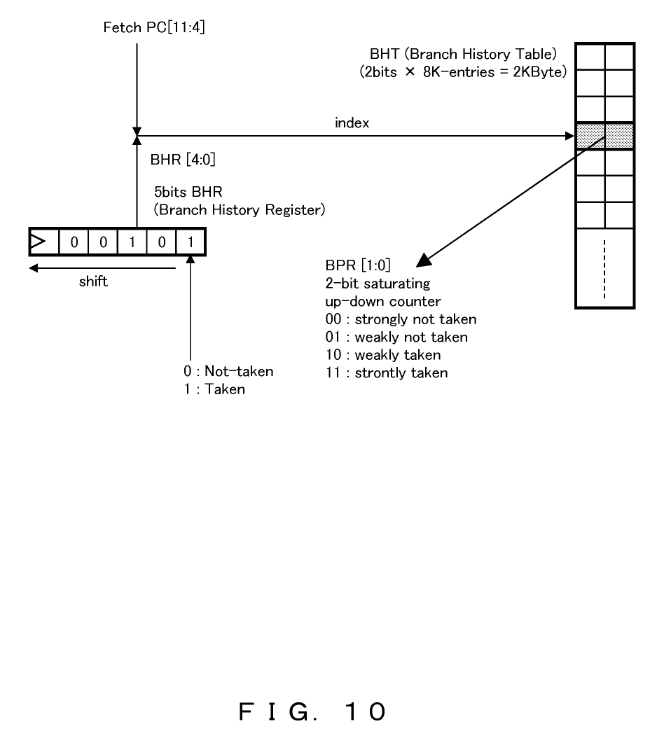

FIG. 10 is a diagram describing a branch prediction method using BHT.

The branch history table (BHT) stores “00” (a high probability of Not Taken), “01” (a low probability of Not Taken), “10” (a low probability of Taken) and “11” (a high probability of Taken) in each address in 2-bit form, respectively. When the BHT is searched, an index obtained by combining the lower bit of a program counter (i.e., fetch PC) used for an instruction fetch and a BHR (branch history register) bit is used. The BHR indicates how the branch instructions have been branched in order of execution when a program is sequentially executed, regardless of which branch instruction the branch history is for. In the case of FIG. 10, it is a 5-bit register. That is, the BHT stores either that the branch instruction is Taken or Not Taken retroactively up to the fifth branch instruction from the present executing position along the program. In other words, it is in a local branch prediction in which the BRHIS and the WRGHT carry out a branch prediction for each branch instruction by utilizing the branch history of each branch instruction. In contrast, the BHT method uses a global branch history in terms of the fact that the history of the BHR is to be found along the flow of a program and is not concerned with what branch instruction the history is for. Therefore, a branch prediction using the BHT is a branch prediction comprehending a global content in terms of not only which instruction is to be specified using a program counter PC, but also using the history of BHT as well to carry out a branch prediction.

Both the BHT method and the BRHIS & the WRGHT have strengths and weaknesses in a branch prediction and therefore it is inappropriate to say that either method is superior to the other. Rather, appropriately using one or the other of the methods in different situations is considered to be good.

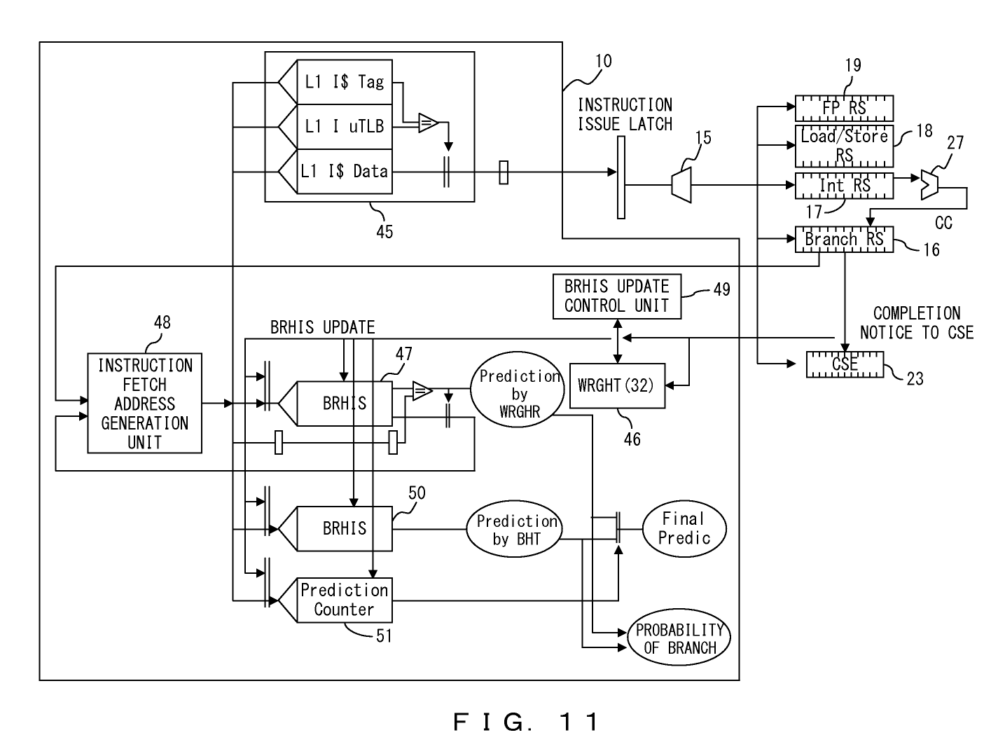

FIG. 11 is a diagram showing an exemplary configuration for detecting a branch prediction probability by means of a combination between BHT and BRHIS.

In FIG. 11, the same reference sign is assigned to the same constituent component as in FIG. 8 and the description is not provided here.

The configuration of FIG. 11 is similar to that of FIG. 8 but is also equipped with a BHT 50 and a prediction counter 51. The BHT 50 is provided for carrying out a branch prediction in collaboration with the WRGHT 46 & BRHIS 47, wherein the prediction counter 51 selects the result of a branch prediction from either one (i.e., 50 or 46/47) as the final result of branch prediction. The probability of branching, in the case of a prediction from the BHT, can be seen to be either high or low just by looking at the output bit, as is clear from the above description, while in the case of a prediction from the WRGHT & BRHIS, it can be seen to be either high or low just by looking at the Dizzy flag.

The prediction counter 51 is obtained by combining two of the above described 2-bit saturation counters, with one used as a WRGHT & BRHIS-use counter and the other used as a BHT-use counter. The saturation counter is configured to change the counter value by +1 if the branch prediction is hit and change it by −2 if the branch prediction is missed, and therefore the larger the counter value, the higher the probability of a branch prediction resulting in it being selected from between the BHT and WRGHT & BRHIS.

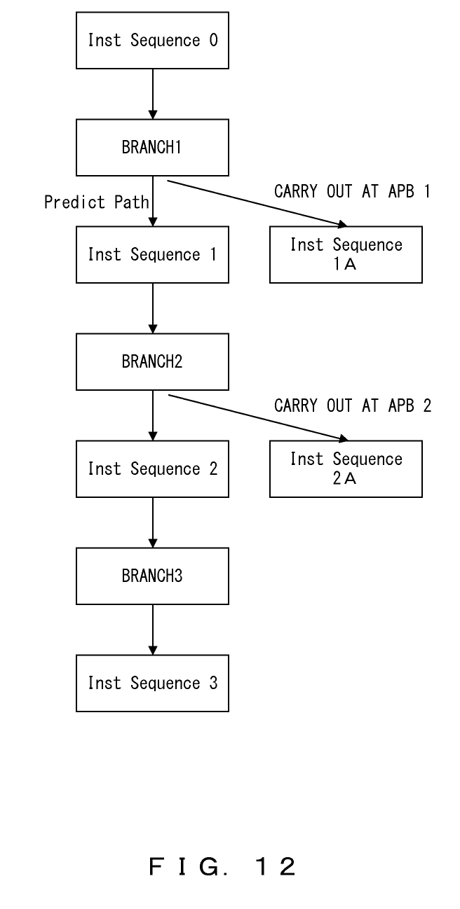

FIG. 12 is a diagram describing a usage pattern of an APB and the preferred embodiment of the present invention.

As described above, the APB is a mechanism for fetching the instruction for a branch in a direction different from the branch-predicted side and inputting it into an execution system. In the following it may be considered for a case in which the number of entries of the APB is two and the APB is used in sequence. In the case of FIG. 12 the assumption is, first, that the instruction sequence 0 is executed and the process is advanced to the branch instruction 1. In the instruction sequence for an instruction that has been predicted as branching, a fetch from an instruction buffer is performed as the instruction sequence 1, and the instruction is input into an execution system such as a decoder, a reservation station, or the like. Meanwhile, an instruction which has not been predicted as branching and the subsequent instruction are also fetched from the first entry of the APB as instruction sequence 1A and are input into the execution system. Here, although both the instruction sequence from the instruction buffer and the instruction sequence from the APB need to be input into the execution system, the configuration in this case is such that a selector (i.e., the selector 14 shown in FIG. 1) that is used for selecting the instruction buffer and APB carries out an operation such as selecting the instruction buffer and APB alternately for every machine cycle, thereby inputting the instruction sequences from them into the execution system. This prompts a branch destination to be established and thereby an instruction sequence from either the instruction buffer or the APB may be a wrong sequence. However, a wrong instruction sequence is not committed in this case and may be deleted from the CSE when the branch destination is established.

In FIG. 12, assuming that the instruction sequence 1 is the correct instruction sequence, then the branch instruction 2 is reached. Here, a branch prediction is carried out once again, and the predicted instruction sequence is fetched from the instruction buffer as an instruction sequence 2 and is input into the execution system. Meanwhile, the APB is configured to have two entries and therefore, also in the second branch prediction, the instruction sequence in the opposite direction to the predicted direction is fetched to the second entry of the APB as an instruction sequence 2A and is input into the execution system. Then, when the instruction sequence reaches a branch instruction 3, a branch prediction is likewise carried out. This time, however, there is no spare entry in the APB, and therefore it is not possible to input an instruction sequence in an opposite direction to the predicted direction. Therefore, the problem produced by the present invention occurs. Accordingly, if the APB is used up, the above described embodiment of the present invention is carried out to make the instruction sequence 3 the target of an instruction issuance stop control.

Note that the above described embodiment has described the operation of stopping the issuing of a next instruction to a conditional branch instruction. In an instruction set for a machine such as SPARC, there is the problem that a delay slot exists; that is, an instruction down to the next line of a branch instruction is issued, followed by skipping to issuing an instruction at the branch destination. In this case, an issuance may be stopped by an instruction subsequent to a delay slot.

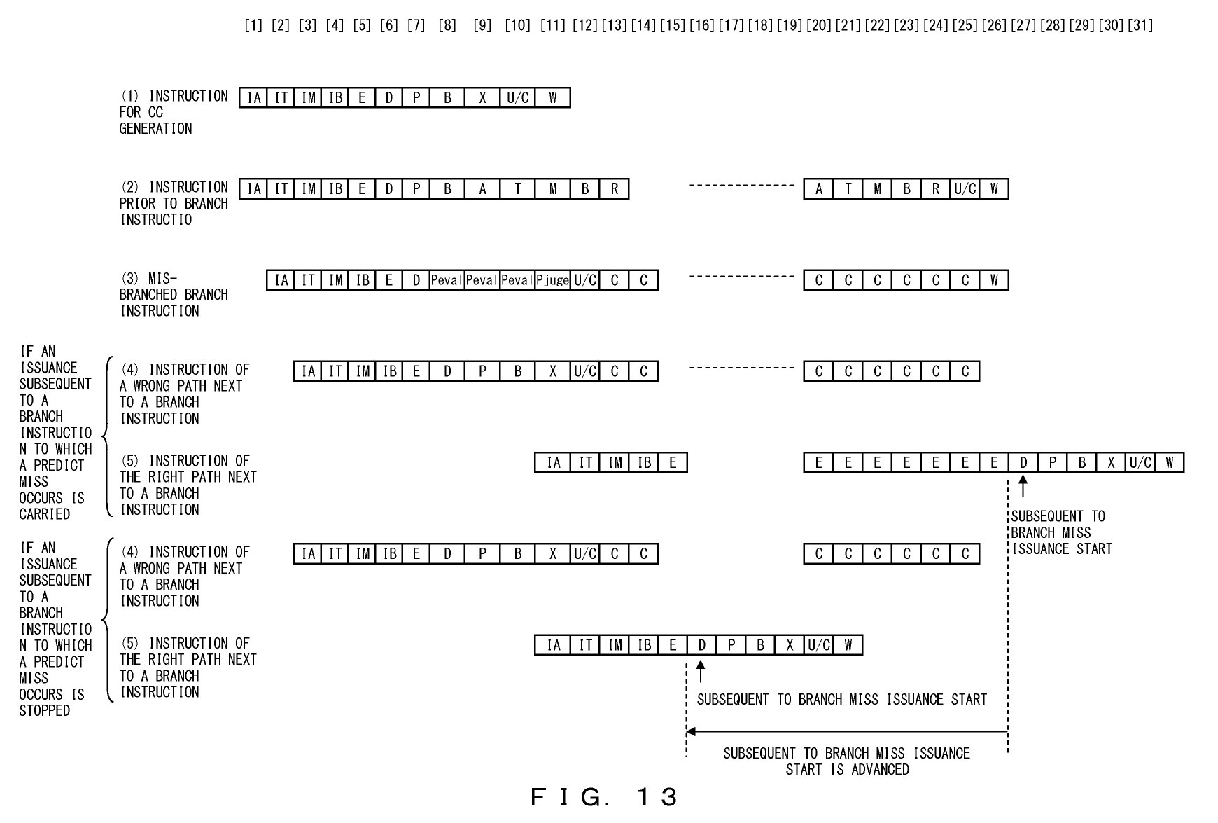

FIG. 13 is a diagram showing an exemplary timing indicating an effect provided by the present invention.

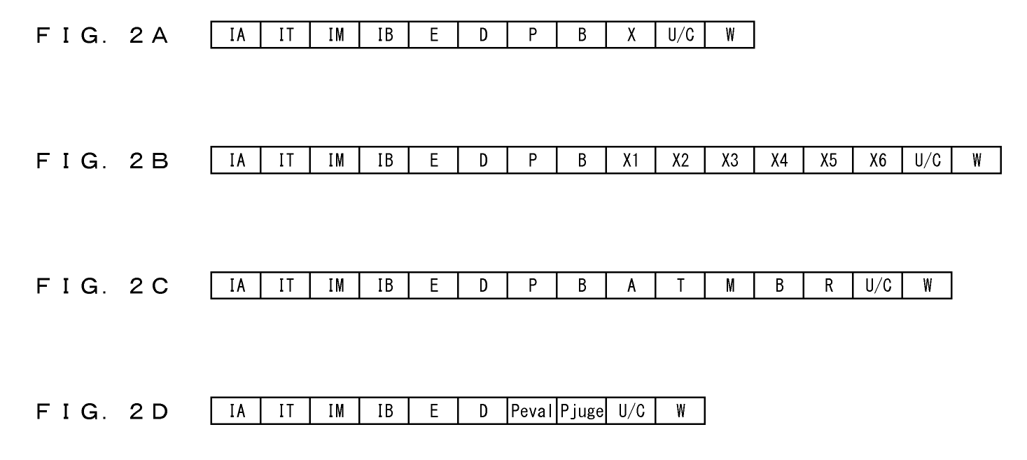

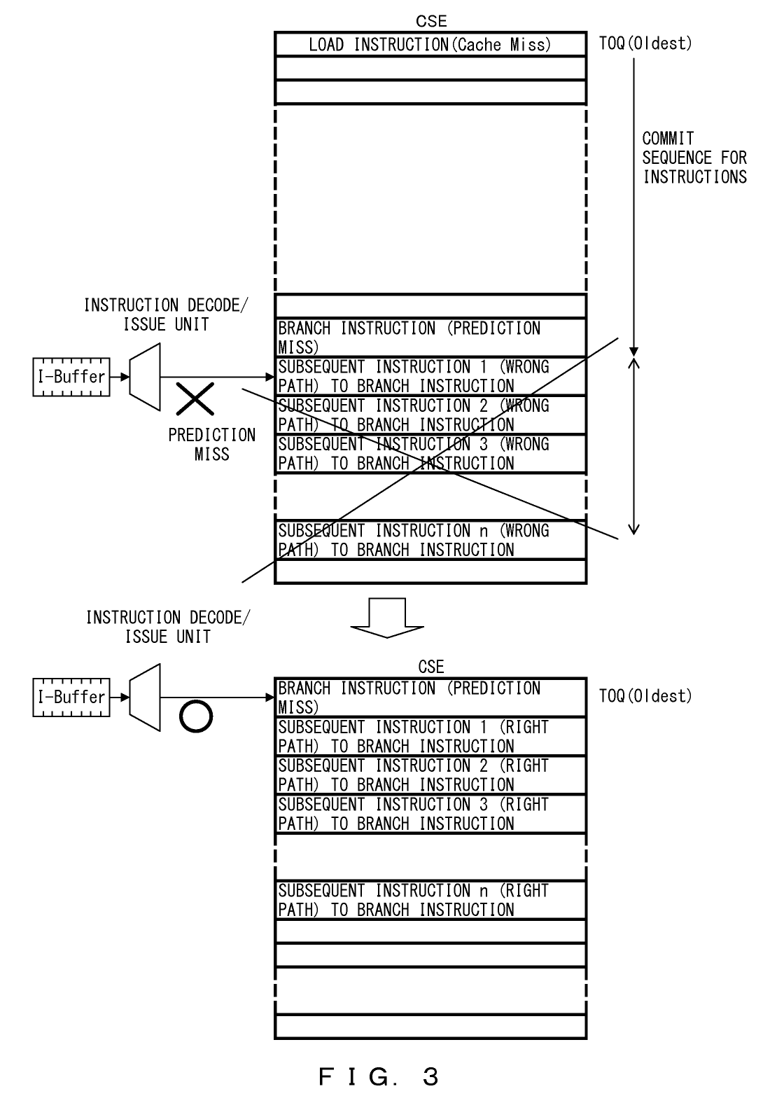

Referring to FIG. 13, each sign of a machine cycle is the same as in FIG. 2.

A branch instruction (3) receives a CC generated by the instruction (1) at (the timing) [10], a branch miss is uncovered at [11], and an instruction fetch for the head instruction (4) of the correct path is started. Instruction (2) is a load instruction, and the L1 data cache pipeline is initiated at [16] in synchronization with a timing at which the data for which a cache miss occurred and mis-cached can now be supplied. Since a commit is performed in order, the commit for instruction (3) may wait until [26] instruction (2) is simultaneously committed. If a subsequent instruction to the branch instruction is already issued, the E cycle of an instruction (5) becomes possible after the W cycle [26] of instruction (3) and therefore an instruction issuance for instruction (5) and thereafter may have to wait until then. If the issuance of a subsequent instruction to the branch instruction is suppressed, it is possible to issue the instruction of the correct path immediately at [16].

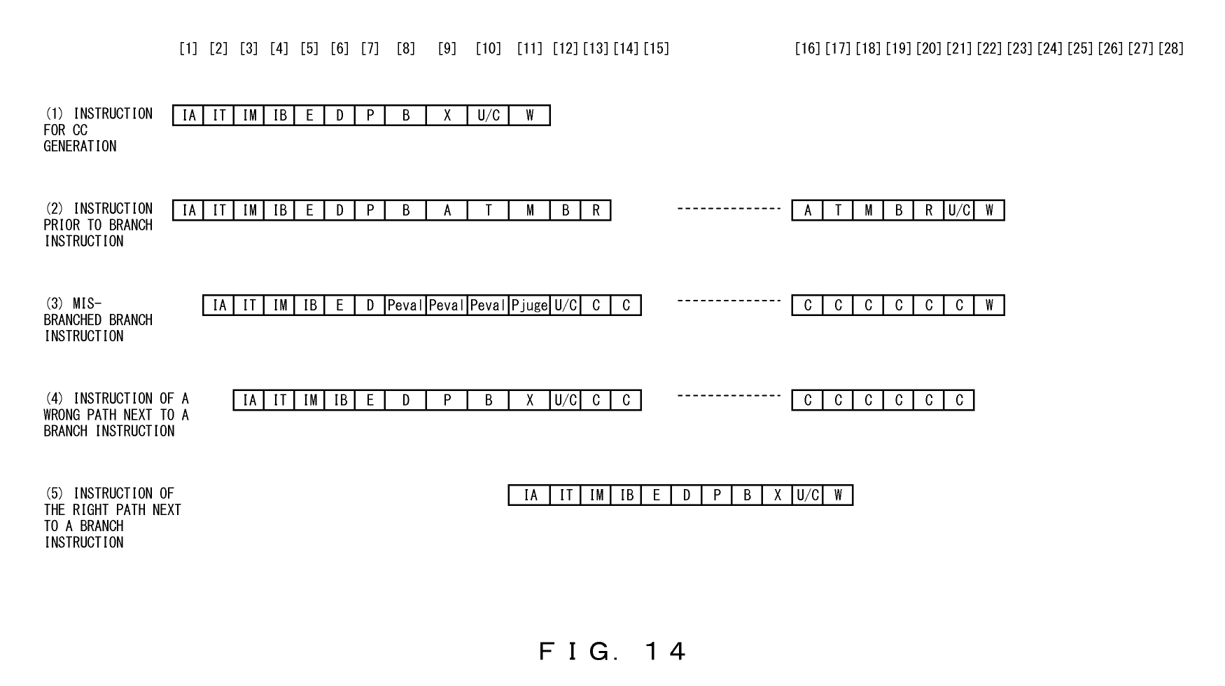

FIG. 14 is a diagram showing an exemplary instruction execution cycle when comprising a mechanism retaining a renaming map for each branch instruction and rewriting the map at a branch miss as a trigger.

Referring to FIG. 14, each sign of a machine cycle is the same as in FIG. 2.

A branch instruction (3) receives a CC generated by the instruction (1) at [10], a branch miss is uncovered at [11], and an instruction fetch for the head instruction (4) of the correct path is started. Instruction (2) is a load instruction, and the L1 data cache pipeline is initiated at [16] in synchronization with a timing at which the data for which a cache miss occurred and mis-cached can now be supplied. Since a commit is performed in order, the commit for instruction (3) may wait until [26] when instruction (2) is simultaneously committed. Although the renaming map is in the state of instruction (4), which has been issued at the end of a wrong path, the issuance of an instruction of the correct path at instruction (5) and thereafter can be carried out without waiting for the commit of the branch instruction (3) by returning to the state of the branch instruction (3) to [15].

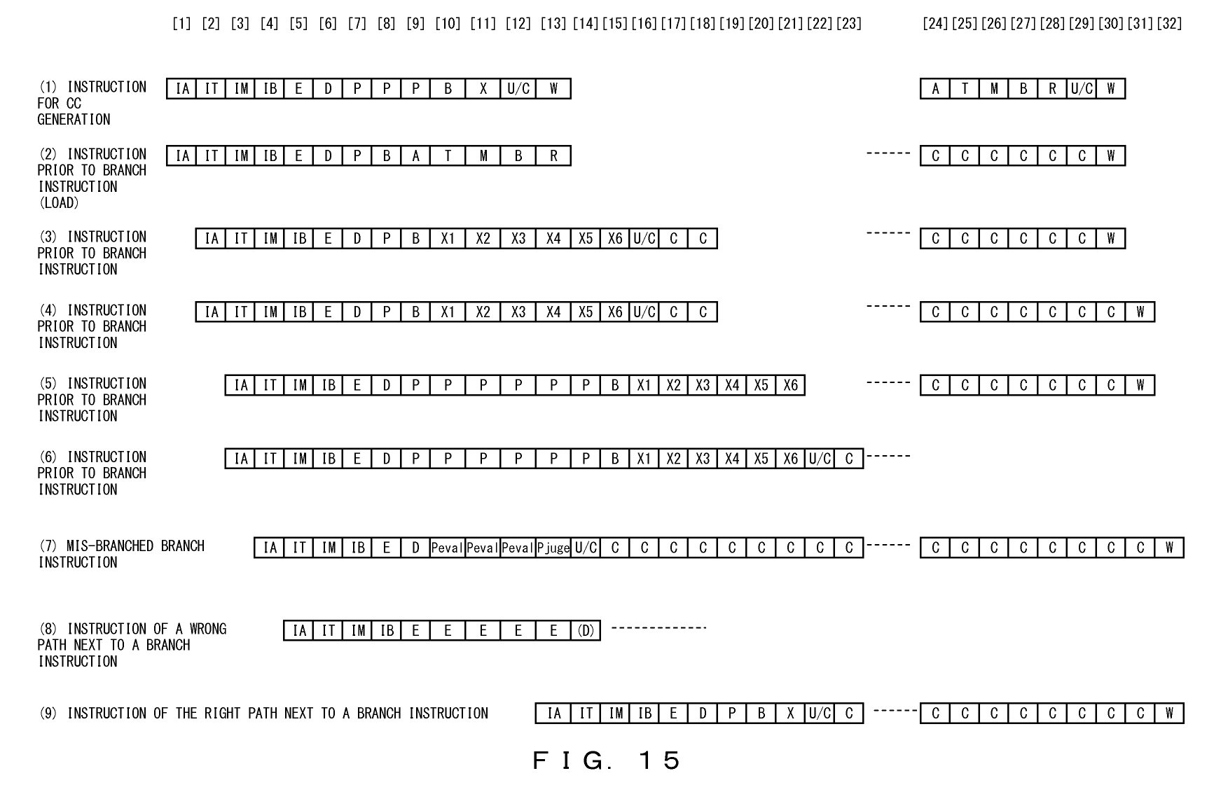

FIG. 15 is a timing chart showing an exemplary operation of [method 1] and [method 2].

A branch instruction (7) receives a CC generated by instruction (1) at [12], a branch miss is uncovered at [13], and an instruction fetch for the head instruction (9) of the correct path is started. Instruction (2) is a load instruction, and the L1 data cache pipeline is initiated at [24] in synchronization with a timing at which the data for which a cache miss occurred and mis-cached can now be supplied. At the branch instruction issuance of instruction (7), an issuance instruction stop condition is detected at [9], and the instruction issuance thereafter is stopped. A commit is carried out in order and therefore the commit of instruction (3) may wait until [22] when instruction (2) is simultaneously committed. The renaming map is in the state of the missed branch instruction and therefore the instruction of the correct path at (9) and thereafter is issued at [18] without waiting for the commit of the branch instruction (7), and the instruction of the wrong path next to the branch instruction of (8) is deleted from the instruction fetch pipeline. Further, if the prediction of the branch instruction (7) has been the correct path, the E cycle of [13] when it is uncovered to be the correct path becomes valid, and therefore an instruction issuance is restarted at [14].

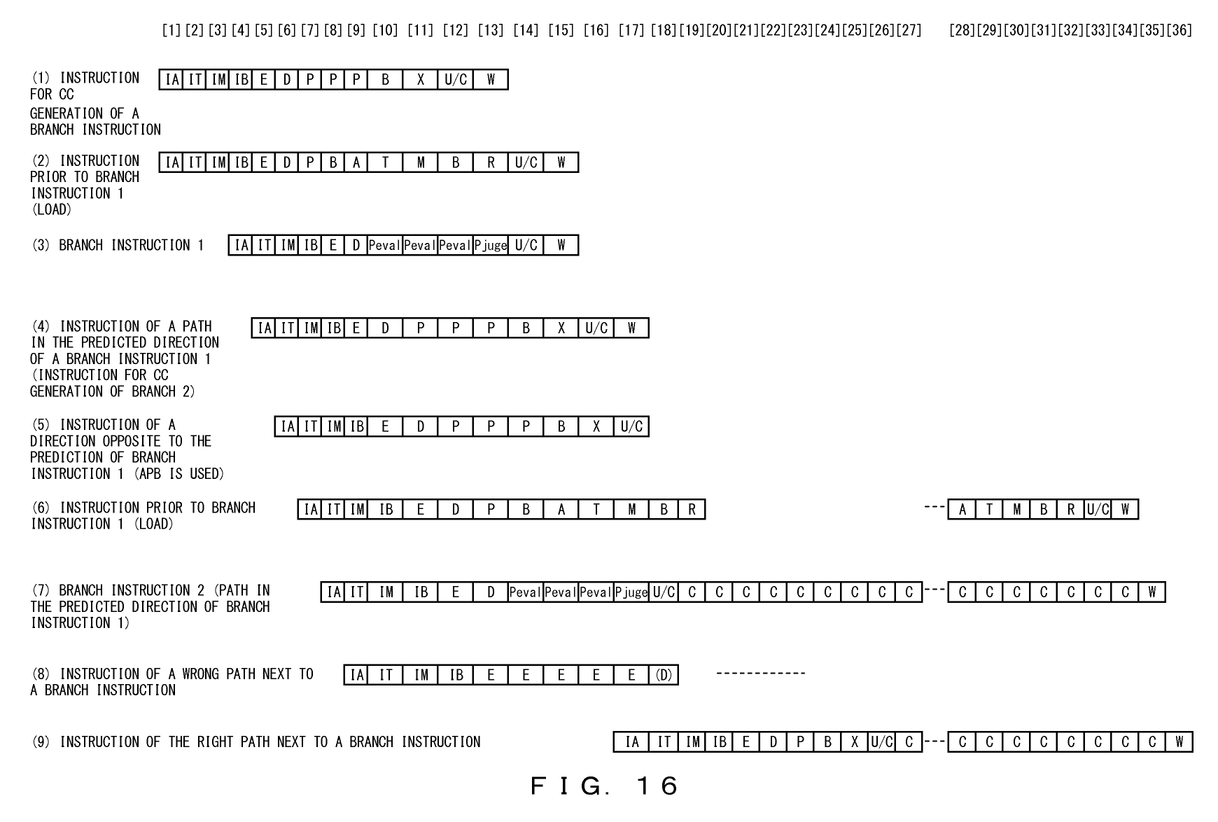

FIG. 16 is a timing chart showing an exemplary machine cycle in the case of applying the present invention when a one-entry APB is comprised.

Referring to FIG. 16, each sign of a machine cycle is the same as in FIG. 2.

The branch instruction 1 of the instruction (3) is fetched; the fact that there is a spare in the entry of an APB so that the condition for using the APB is satisfied is judged; the instruction fetch (4) in the correct direction of a prediction is continued, while an instruction fetch (5) in an opposite direction to the prediction is started and stored in the APB; and an instruction is issued from the APB. The branch instruction (2) of an instruction (6) determines that the condition for stopping the issuance of a subsequent instruction is satisfied because the APB is used up, or because of other conditions, and causes the instruction issuance of a subsequent instruction (8) to be halted. Although the branch instruction (2) of (7) brings about a prediction miss, an instruction issuance of the right path can be started without waiting for the commit of the branch instruction. If an APB is used, a subsequent instruction issuance is stopped after the APB is used up and therefore a risk of degraded performance due to stopping an instruction issuance can be further suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus performs a branch prediction of a branch instruction and executes an instruction speculatively, comprising:
a cache miss detection unit detects a cache miss of a load instruction;
an instruction issuance stop unit stops the issuance of an instruction subsequent to a conditional branch instruction if the branch direction of the conditional branch instruction subsequent to the load instruction is not established at the timing of issuance, wherein
a period of time for cancelling an issued instruction, the cancelling having been caused by a branch prediction miss, is deleted and thereby a penalty for the branch prediction miss is concealed under a wait time caused by a cache miss.

2. The information processing apparatus according to claim 1, further comprising
a dependency detection unit detects dependency between the load instruction and the conditional branch instruction subsequent thereto, wherein
the issuance of an instruction subsequent to the conditional branch instruction is stopped if there is not a dependency between the load instruction and the conditional branch instruction.

3. The information processing apparatus according to claim 1, further comprising
a cache miss prediction unit predicts whether or not a cache miss occurs in an issued load instruction before whether or not a cache miss occurs in the load instruction is established, wherein
the issuance of an instruction subsequent to said conditional branch instruction is stopped if the cache miss prediction unit predicts a cache miss.

4. The information processing apparatus according to claim 3, wherein
the issuance of an instruction is restarted if a load instruction for which said cache miss prediction unit had predicted a cache miss has proven to be a hit, and the issuance of an instruction is immediately stopped if a load instruction for which the cache miss prediction unit had predicted a hit has proven to be a cache miss.

5. The information processing apparatus according to claim 3, wherein
the cache miss prediction unit is furnished with a history of a cache miss and a hit related to the execution of the past load instructions.

6. The information processing apparatus according to claim 1, further comprising
a branch prediction probability detection unit detects the probability of a branch prediction at an instruction fetch of said branch instruction, wherein
the issuance of an instruction subsequent to the conditional branch instruction is stopped if the probability of the branch prediction of the conditional branch instruction is low.

7. The information processing apparatus according to claim 1, wherein
the issuance of an instruction subsequent to a conditional branch instruction is stopped if a mis-cached load instruction and the subsequent conditional branch instruction are the number of lines indicated by a threshold value apart from each other along the instruction string of a program.

8. The information processing apparatus according to claim 1, further comprising
a predicted side execution unit fetches a predicted instruction and inputting it into an execution system; and
an unpredicted side execution unit fetches an unpredicted instruction and inputting it into an execution system, wherein
the issuance of an instruction subsequent to the conditional branch instruction is stopped if the unpredicted side execution unit no longer process the fetch or execution of an unpredicted instruction.

9. The information processing apparatus according to claim 1, wherein
the issuance of an instruction next to a delay slot and thereafter is stopped if the information processing apparatus adopts an instruction set architecture equipped with a delay slot.

10. A control method used for an information processing apparatus which performs a branch prediction of a branch instruction and executes an instruction speculatively, the control method comprising:
detecting a cache miss of a load instruction;
stopping the issuance of an instruction subsequent to a conditional branch instruction if the branch direction of a conditional branch instruction subsequent to the load instruction is not established at the timing of issuance; and
deleting a period of time for cancelling an issued instruction, the cancelling having been caused by a branch prediction miss, and thereby a penalty for the branch prediction miss is concealed under a wait time caused by a cache miss.
